(19) United States
(12) Patent Application Publication
(10) Pub. No.: US 2001/0001671 A1
(43) Pub. Date: May 24, 2001

(54) PRODUCT PREPARATION SYSTEM WITH EXTRUSION HORN

(76) Inventors: WARD HALVERSON, BERLIN, MD (US); RODGER HENDRIX, SEWELL, NJ (US); MICHAEL LESIAK, VOORHESS, NJ (US)

Correspondence Address: BAKER AND BOTTS, THE WARNER, SUITE 1300, 1299 PENNSYLVANIA AVENUE N W, WASHINGTON, DC, 200042400

(21) Appl. No.: 09/190,296

(22) Filed: Nov. 13, 1998

Related U.S. Application Data
(60) Provisional application No. 60/065,812, filed on Nov. 14, 1997.
(60) Provisional application No. 60/066,754, filed on Nov. 21, 1997.

(51) Int. Cl. B29C 47/00

(52) U.S. Cl. 425/377

(57) ABSTRACT

A food preparation system is disclosed comprising a food products container, a pump, and an extrusion horn that allows food products to be shaped to a uniform cross-section and deposited onto a moving surface for further processing. The pump provides a regulated, continuous flow of food products to the extrusion horn and may be a centrifugal pump with sine-wave shaped impellers. The extrusion horn has an opening which is preferably oblong-shaped, with an average width much greater than its average height. The food products are pumped through enclosed conduits, continuously extruded through the extrusion horn with a uniform thickness and width, and then directly deposited onto the moving surface for further processing, such as heating, freezing, breading, or the like.

### BACKGROUND OF THE INVENTION

1. Field of the Invention

The invention relates to a system for processing products, such as food products. In particular, it relates to a system for treating and transporting products between various processing stages in an efficient and sanitary manner.

2. Description of Related Art

A wide variety of products, such as food products, require processing before use by or sale to consumers. Generally, food products are processed in various combinations of a plurality of stages, for example marinating, cutting, deboning, breading, adding spices, cooking, dicing, brazing, searing, freezing, and packaging, and combinations thereof. In particular, a known processing system provides for the transportation of meat food products, such as chicken breasts or tenders, from a marinating tumbler to an oven. The meat food products are deposited onto an uncovered oven belt, which passes through an oven to cook the meat food products. In such a system, a plurality of uncovered conveyor belts are used to transfer the meat food product from the marinating tumbler through a press belt and onto the oven belt. A plurality of operators also are employed to ensure that the meat food products are evenly distributed on the conveyor in order to reduce floor loss and on oven belts in order to cook the meat food products uniformly and thoroughly.

Such an uncovered processing system, in which the food products are not transported in enclosed conduits, but rather, are exposed to the atmosphere between the various processing stages, has several disadvantages. An uncovered system does not prevent the food products from falling off or through mesh type conveyors while being transported, and, thus, may experience significant floor loss. Floor loss may reach significant amounts, e.g., about 100 pounds on a daily basis. The food products transported on uncovered conveyor belts also are exposed to air borne dust, machinery lubricants, spores, bacteria, and the like. Further, the food products tend to lose moisture due to the exposure to air. An uncovered processing system also may experience marinade loss during transport, which marinade may collect on the floor or on system machinery, or both, and result in unsanitary conditions. Moreover, because the food products generally are not uniformly deposited on the oven belt, the available surface area of the oven belt is not entirely and efficiently utilized, which may result in an inadequate throughput and yield of the system.

### SUMMARY OF THE INVENTION

It is desirable to use efficient, bulk capacity equipment, e.g., equipment capable of use with large amounts of a product with little or no loss, in the treating and transportation of food products during and among a plurality of processing stages. It also is desirable to eliminate or reduce losses associated with the various processing stages and the transport mechanisms therebetween to increase the throughput and yield of the system and achieve operating cost reductions. Accordingly, a need has arisen for a system for transporting products, including food products, such as chicken breasts or tenders, during processing in an efficient and sanitary manner with little or no damage to or loss of the food products. In particular, it is an object of the invention to provide a food preparation system that reduces or eliminates the foregoing problems.

It is an object of the invention to provide an efficient, food preparation system that increases or improves, or both, the overall throughput and yield of the system. It is a feature of the invention to have a pump that provides a regulated and continuous flow of food products through the system. It is an advantage of the invention that the pump allows greater control over the pumping process and product flow and, thereby, increases efficiency. It is another feature of the invention to have an extrusion horn formed to shape the extruded, food products. It is yet another advantage of the invention that the outlet of the extrusion horn allows greater control over the dimensions of the extruded, food products. It is still another advantage of the present invention that the pumped food products are shaped to have a substantially uniform cross-section, allowing consistency in later processing stages. It is a further advantage of the invention that the extrusion horn flattens and compresses the pumped food products to a substantially uniform thickness and width, ensuring increased or improved, or both, utilization of a moving surface, e.g., conveyor belt, area that receives the extruded food products. It is further still an advantage of the invention that the uniform thickness and width of the extruded, food products result in the extruded, food products substantially retaining their shape during subsequent processing stages.

It is another object of the invention to provide an efficient food preparation system that increases or improves, or both, cooking yield. It is an advantage of the invention that the substantially uniform thickness and width of an outlet of the extrusion horn permit greater control over the dimensions of the food products stream and the placement of the food products on an oven belt, thereby increasing or improving cooking yield, or both. It is another advantage of the invention that the substantially uniform cross-section of the food products stream results in a more uniform internal temperature and thorough heating of the food products.

It is yet another object of the invention to increase or improve oven capacity, or both. It is an advantage of the invention that the uniform stream of food products emerging from the outlet of the extrusion horn results in uniform oven loading. It is another advantage of the invention that more uniform, food product heating characteristics enable the oven to be operated at a lower target temperature, e.g., the oven temperature required for thoroughly cooking the food products, and reduce cooking time. It is still another advantage of the invention that the compression of the food products reduces the air therebetween and thus improves heat transfer within the food products stream. It is yet another advantage of the invention that the uniform thickness and width of the flattened food products placed on the oven belt result in consistent air flow over and around the food products and improved heat transfer to the food products.

It is still another object of the invention to provide a food preparation system that produces uniformity in cooked food product dimensions. It is an advantage of the invention that the food products are compressed by the extrusion horn, resulting in reduced dimension changes during cooking. It is yet another advantage of the invention that the substantially uniform cross-section of the food products stream allows greater dimensional control for size-sensitive stages, such as dicing and canning. It is still another advantage of the invention that the control over food product dimensions and throughput of the system permits bone detection apparatus to be placed in-line when needed for product screening.

It is a further object of the invention to provide an efficient and sanitary food preparation system that eliminates or reduces floor loss, marinade loss, and loss of moisture during transport. It is a feature of the invention to have the food products transported through enclosed conduits. It is an advantage of the invention that the enclosed conduits of the system result in a more sanitary operation by eliminating or reducing floor loss, marinade loss, and loss of moisture. It is another advantage that the overall throughput of the system may be increased by the elimination or reduction of the floor loss, marinade loss, and moisture loss.

It is yet a further object of the invention to provide a food preparation system that may be more readily and thoroughly cleaned. It is an advantage of the invention that the system may be readily cleaned by pumping cleaning or sterilizing fluids through enclosed conduits. It is another advantage of the invention that a director portion of the extrusion horn may comprise a top portion and a bottom portion, which may be readily removed for easy cleaning.

It is still a further object of the invention to provide a food preparation system that reduces labor costs. It is an advantage of the invention that the food preparation system eliminates the need for some operators, resulting in a reduction of labor costs.

In an embodiment, the invention relates to a food preparation system and comprises a food products container, at least one pump, at least one extrusion horn, and at least one moving surface. Preliminary processing may occur in the food products container. For example, the food products container may be used to marinate food products, such as chicken breasts or tenders. The food products container may comprise a marinater, such as a marinating tumbler. The pump receives the food products from the food products container and pumps the food products in a regulated and continuous stream to the extrusion horn. The pump may be a centrifugal pump having a sine-wave shaped impeller to provide the regulated and continuous flow and permit greater control over the pumping process than may be achieved with piston-type pumps. The food products are pumped to the extrusion horn through an enclosed conduit and emerge from an outlet of the extrusion horn and are thereby formed into a stream having a substantially uniform cross-section. The stream is deposited onto the moving surface and may be transported for further processing, such as heating, freezing, cutting, breading, dicing, or the like.

In another embodiment, the extrusion horn has an oblong opening, e.g., an opening with an average width greater than its average height. This causes the food products stream to emerge from the outlet of the extrusion horn with a predetermined thickness and width before being deposited onto the moving surface. In still another embodiment, the extrusion horn has a spreader portion and a director portion to compress the food products. Specifically, the spreader portion increases the width and decreases the height of the stream, and the director portion limits the width of the stream. The director portion has a first converging portion that limits the width of the stream to further compress the food products and a second extended length portion of uniform dimensions to retain the compressed state of the food products stream. The food products stream emerges from the extrusion horn with a width less than the width of the moving surface, e.g., less than about 95% and preferably, in a range of about 75% to about 95%, of the width of the moving surface, and is then deposited onto the moving surface, resulting in the increased or improved, or both, utilization of the moving surface area. In yet another embodiment, the moving surface is an oven belt, and the compression of the food products stream by the extrusion horn significantly reduces dimensional changes of the food products during cooking.

Other objects, features, and advantages will be apparent to persons skilled in the relevant art in view of the following detailed description and the accompanying drawings.

### BRIEF DESCRIPTION OF THE DRAWINGS

For a more complete understanding of the present invention and the advantages thereof, reference is now made to the following description taken in conjunction with the accompanying drawings, where like reference numerals represent like reference parts, wherein:

FIG. 1 is an overhead view of the food preparation system in accordance with an embodiment of the present invention.

FIG. 2 is a side view of the food preparation system depicted in FIG. 1.

FIG. 3 is an enlarged, perspective view of an extrusion horn according to an embodiment of the present invention.

FIG. 4 is a partial, perspective view of a food preparation system having a plurality of parallel extrusion horns in accordance with another embodiment of the present invention.

FIG. 5 is a partial, perspective view of a food preparation system having a plurality of pumps in accordance with another embodiment of the present invention.

FIG. 6 is a partial, perspective view of a food products container in accordance with yet another embodiment of the present invention.

FIG. 7 is an overhead view of an extrusion horn in accordance with a preferred embodiment of the present invention.

FIG. 8 is a side view of the extrusion horn depicted in FIG. 7.

### DETAILED DESCRIPTION OF PREFERRED EMBODIMENTS

FIGS. 1 and 2 depict a system for transporting food products including meats, such as chicken breasts or tenders, during processing in a sanitary and efficient manner and with little or no damage to the food products. FIGS. 1 and 2 depict an overhead and side view, respectively, of a food preparation system 1 in accordance with an embodiment of the present invention. Food preparation system 1 comprises a food products container 30, at least one pump 10, at least one extrusion horn 20, and at least one moving surface 40.

Food products, including meat such as chicken breasts or tenders, are held or collected in food products container 30 before being pumped through other components of food preparation system 1. Pump 10 receives the food products from container 30 and delivers the food products in a regulated and continuous stream to extrusion horn 20. Extrusion horn 20 has an outlet 21 to shape a food products stream 25. Moving surface 40 receives stream 25 of shaped, food products from outlet 21 and transports stream 25 for further processing.

Preliminary processing may occur in food products container 30. For example, container 30 may be used to marinate food products such as chicken breasts or tenders, and may comprise other suitable pre-processing equipment. For example, container 30 may comprise a marinater 31 and a collection hopper 32. Further, marinater 31 may be a marinating tumbler. The marinated food products may be transferred from marinating tumbler 31 to collection hopper 32 and subsequently delivered to pump 10.

Pump 10 receives the marinated or otherwise treated food products from food products container 30 and provides a regulated and continuous flow of food products to extrusion horn 20. Pump 10 may be a centrifugal pump having a sine-wave shaped impeller. Such centrifugal pumps provide superior control over the pumping process compared to piston-type pumps.

Extrusion horn 20 receives regulated and continuous stream 25 of food products from pump 10. Extrusion horn 20 may be fabricated from stainless steel or other rigid, substantially non-porous materials including metals, polymers, and ceramics. As noted above, outlet 21 of extrusion horn 20 shapes food products stream 25. The pumped food products emerge from outlet 21 of extrusion horn 20 with a substantially uniform cross-section, allowing consistency in later processing stages. Shaped food products stream 25 exiting extrusion horn 20 is deposited onto a moving surface 40. Moving surface 40 may be a conveyor belt, which may be aligned with outlet opening 21 of extrusion horn 20, such that food products stream 25 is extruded in a direction of movement of the conveyor belt, as shown in FIG. 3. In particular, an embodiment of such a conveyor belt may be an oven belt. Shaped food products stream 25 emerging from extrusion horn 20 may be delivered to and transported via moving surface 40 for further processing, such as heating, freezing; cutting; breading; dicing; applying spices, seasonings or preservatives; or the like.

Referring again to FIG. 3, outlet 21 of extrusion horn 20 has an oblong shape, with an average width much greater than its average height, e.g., average width is in a range of about 15 to about 30 times average height. Nevertheless, the advantages of extrusion horn 20 and the resultant uniform cross-section of shaped, food products stream 25 may be realized regardless of whether outlet 21 of extrusion horn 20 is oblong-shaped, with a uniform width and thickness. A uniform cross-section that is not oblong-shaped may be beneficial and cost-effective for a plurality of processes and a variety of aesthetic and practical reasons, and may achieve the overall objects of the invention because of the uniform dimensions achieved with respect to the material placed on the belt. For example, a uniform circular cross-section may be desirable for forming hamburger patties or sausage links, and a “D”-shaped cross-section forming a flat surface which may be placed in contact with the moving belt also may be desirable for other applications.

The oblong shape of outlet 21 of extrusion horn 20 having a uniform width and height as depicted in FIG. 3, however, provides additional advantages. The oblong shape of outlet 21 results in food products stream 25 emerging from outlet 21 of extrusion horn 20 with a substantially uniform and predetermined width and thickness. The uniform width and thickness of the emerging food products stream 25 facilitate subsequent processing stages. In cooking, for example, the uniform width and thickness of food products stream 25 emerging from outlet 21 of extrusion horn 20 results in a more uniform internal temperature of food products when heated. The reduction in food product temperature variability enables an oven to be operated at a lower target temperature, assuring that food products are thoroughly and uniformly cooked while reducing the required cooking time and energy expended in heating. The uniform dimensions of food products stream 25 also may increase cooking yield, permit better oven capacity utilization, and improve the air flow across and heat transfer to the food products.

It also may be desirable to control the dimensions of the food products for other processing stages. For example, it is important to control the dimensions of diced food products, such as meat, for canning purposes. The uniform dimensions of food products stream 25 exiting outlet 21 of extrusion horn 20 significantly facilitate dimensional control in the later processing stages, such as dicing and canning. The desired width and thickness of outlet 21 may be varied for different processing stages to ensure a higher yield and more efficient operation of the food preparation system.

FIGS. 2, 5, and 6 illustrate a first conduit 33 which places food products container 30 in communication with at least one pump 10 that provides a regulated, continuous flow. Pump 10 is preferably a centrifugal pump having a sine wave shaped impeller. The marinated or otherwise treated food products are transported from food products container 30 through at least one first conduit 33 to at least one pump 10. First conduit 33 may be a funnel-shaped portion at a bottom end of collection hopper 32, in which the food products are gravity fed to at least one pump 10. There may also be a plurality of conduits 33 placing the food products container 30 in communication with pump(s) 10, as shown in FIG. 5.

Referring generally to FIGS. 1-5, a second conduit 12 places centrifugal pump 10 in communication with extrusion horn 20. The food products are pumped through second conduit 12 to extrusion horn 20. Second conduit 12 may be enclosed pipe and substantially reduces or eliminates any floor loss, marinade loss, or loss of moisture during transportation of the food products. Further, the enclosed conduit 12 substantially reduces or eliminates exposure of the food products to dust, machinery oil, spores, bacteria, or the like. Second conduit 12 also allows for a more sanitary operation of the entire system and simplifies the process of cleaning the equipment after processing has been completed, thereby facilitating compliance with health and safety regulations. This system, unlike known uncovered processing systems, may be readily cleaned by pumping cleaning fluids, including disinfecting, anti-bacterial, or sporicidal liquids, through conduits 33 and 12.

Referring particularly to FIGS. 4 and 5, a plurality of first conduits, such as first conduits 33 and 33′, delivering food products from container 30 to pumps 10 and 10′, respectively, and a plurality of second conduits such as second conduits 12 and 12′ delivering food products from pumps 10 to extrusion horns 20, are shown. In a preferred embodiment, the food preparation system comprises a food products container 30, two funnel-shaped first conduits 33, and two pumps 10, as shown in FIG. 5. The system further comprises two second conduits 12, two extrusion horns 20, and one moving surface 40, as shown in FIG. 4. Extrusion horns 20 preferably are mounted in parallel. Preferably, moving surfaces 40 are also mounted in parallel, and moving surfaces 40 are oven belts. It will be understood, however, that the number of the various elements utilized in the food preparation system may vary depending on the particular needs of each individual food preparation process. For example, FIG. 4 illustrates a food preparation system comprising a plurality of extrusion horns 20 and moving surfaces 40. FIG. 5 illustrates a food preparation system comprising a plurality of pumps 10 and first and second conduits 33 and 12. The food preparation system disclosed may comprise various combinations of any number of containers, pumps, conduits, extrusion horns, and moving surfaces.

Referring once again to FIG. 3, extrusion horn 20 is depicted as including a spreader portion 22 and a director portion 27. Spreader portion 22 increases a width and decreases a height of food product stream 25 and flattens the food products. Director portion 23 comprises two portions, a first converging portion 23 and a second extended length portion 24. The converging portion 23 limits the width of shaped, food products stream 25 to a width less than a width of moving surface 40 and compresses the food products stream 25, reducing or eliminating air pockets between individual food product pieces. The extended length portion 24 of director portion 27 extends for about 12 inches (30 cm) and retains the compressed state of the food products stream 25 for a period in a range of about 2 to about 10 seconds, depending on the particular food product and the rate at which it is pumped. Preferably, the duration of compression, i.e., dwell time, of the food products must be sufficient to ensure that the food products retain the compressed shape, especially during cooking. For example, in meat food products, the dwell time depends in part on the size of the muscle to be compressed, e.g., the larger the muscle the greater the dwell time required.

As noted above, the dwell time in extended length portion 24 of extrusion horn 20 helps to maintain the shape of the food products stream 25, especially during cooking. Generally, muscle food products, such as chicken breasts or tenders, tend to shorten in the direction of the muscle fibers during cooking and increase in thickness. The compression that occurs within the extrusion horn helps to reduce dimensional changes during cooking. The uniform cooked food product pieces may be used to achieve improved control dimensions during subsequent processes, such as dicing and canning. In addition, extrusion horn director portion 27 may be made from a top portion and a bottom portion (not shown), which may be easily removed for cleaning purposes.

Referring to FIG. 4, the continuously extruded, uniform food products stream 25 emerging from outlet 21 of extrusion horn 20 is deposited onto moving surface 40. In a preferred embodiment, director portion 27 of extrusion horn 20 is oriented substantially parallel to moving surface 40 at an end of second conduit 12. Moving surface 40 may be an oven belt which transports food products stream 25 through an oven 50 in order to cook the food products. Such an oven belt may be a conveyor belt. Alternatively, a series of rollers or other moving surface roller or moving belt device, or the like, may be employed for directing and transporting a product through oven 50.

Stream 25 of shaped food products, having a predetermined width and thickness as described above, significantly facilitates the cooking process by allowing oven 50 to be operated at a lower temperature while, nevertheless, ensuring that the food products are thoroughly and uniformly heated. The uniformity of the thickness of the food products entering oven 50 results in substantially uniform loading of the oven and achieves a substantially uniform internal temperature of the food products. The reduced meat temperature variability enables the oven capacity to be optimized by lowering the target temperature. Further, in order to reduce the internal temperature of the food products, the belt speed may be increased. The compression of the food products through extrusion horn 20 reduces or eliminates air pockets between the individual food product pieces and further improves heat transfer within stream 25. Moreover, the uniformity of food products positioned on oven belt 40 results in a consistent air flow and heat transfer in the oven. In addition, the lower internal temperature variability reduces cooking time and increases the throughput of oven 50.

The increased control over food product dimensions and placement of food products on oven belt 40 enables more food products to be placed on the belt during any time period. The combination of a lower operating oven temperature and improved oven belt area utilization results in an increased throughput, which allows significant savings to be realized by increasing cooking yield in a range of about 3 to about 5 percent by weight. Thus, shaped food products stream 25 emerging from outlet 21 of extrusion horn 20 increases or improves cooking yield, or both.

It will be understood that the advantages of optimizing moving surface area utilization in the foregoing transport process apply equally to other processing stages in which a product stream having a uniform cross-section is desirable, and in particular one requiring a pre-determined, uniform thickness and width. Such a cross-section allows an oven belt, or other moving surface 40, to achieve increased rate of processing or improved capacity, or both. Further, the pumping system with controlled dimensions and throughput enables additional stages to be readily added to a process. In particular, an in-line bone detection device (not shown) may be used when product requirements so demand.

### EXAMPLES

The invention may be further clarified by a consideration of the following examples, which are intended to be purely exemplary of the use of the invention. The food products container 30 may be a Model VT 85 Vacuum Tumbler, manufactured by Food Processing Equipment Co. of Santa Fe Springs, Calif., having a capacity of about 5000 pounds (2,270 kg), a maximum drum speed of about 12 RPM, and an opening diameter of about 30 inches (75 cm). Pumps 10 are preferably centrifugal pumps having sine-wave shaped impellers. For example, the pumps may be Model MR-135 RF Sine Pumps, having rectangular flange inlets for increased volume, manufactured by Sine Pump of Orange, Mass.

In addition, referring to FIG. 7, extrusion horn 20 may be custom made by a metal fabricator, and have a 3 inch (7.5 cm) tri-clamp inlet fitting 29 and an outlet 21 that is about ½ inches (1.25 cm) high and about 9 inches (22.5 cm) wide. Referring to FIG. 8, spreader portion 22 of extrusion horn 20 tapers from circular 3-inch (7.5 cm) inlet opening 29 to an opening 22′ that is about 13¾ inches (34 cm) wide and about ½ inches (1.25 cm) high. Spreader portion 22 is connected to converging portion 23 of the director having a length of about 12 inches (30 cm), which reduces the width from about 13¾ inches (34 cm) to about 9 inches (22.5 cm). Converging portion 23 connects to an extended length portion 24, having a length of about 12 inches (30 cm) which has a uniform width and height of about 9 inches (22.5 cm) and about ½ inches (1.25 cm), respectively.

While the invention has been described in connection with preferred embodiments, it will be understood by those skilled in the art that other variations and modifications of these preferred embodiments described above may be made without departing from the scope of the invention. Other embodiments will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A system for preparing food products comprising:
a food products container;
at least one pump receiving said food products from said container, wherein said pump provides a continuous flow of a food products stream;
at least one extrusion horn receiving said food products stream from said at least one pump, said extrusion horn having an outlet opening for shaping said stream; and
at least one moving surface for receiving said stream.

2. The system of claim 1, wherein said pump is a centrifugal pump having a sine-wave shaped impeller.

3. The system of claim 1, wherein said outlet opening has an opening width and an opening height, and said opening width is greater than said opening height, whereby said extrusion horn shapes said stream to a predetermined extrusion width and thickness.

4. The system of claim 1, wherein said extrusion horn comprises a spreader portion and a director portion, whereby said spreader portion increases a width and decreases a height of said food products stream and said director portion limits said width of said food products stream extruded onto said moving surface to less than a width of said moving surface.

5. The system of claim 4, wherein said director portion comprises a converging portion and an extended length portion.

6. The system of claim 5, wherein said director portion comprises a top portion and a bottom portion, wherein said top and said bottom portions are removable for cleaning.

7. The system of claim 1, wherein said extrusion horn is fabricated from a material selected from the group consisting of metals, polymers, and ceramics.

8. The system of claim 7, wherein said material is stainless steel.

9. The system of claim 1, wherein at least one first conduit places said container in communication with said pump.

10. The system of claim 9, wherein said first conduit is a funnel-shaped portion located at a bottom end of said container, whereby said food products are gravity fed to said pump.

11. The system of claim 1, wherein at least one second conduit places said pump in communication with an inlet opening of said extrusion horn.

12. The system of claim 1, wherein said moving surface is an oven belt.

13. The system of claim 1, wherein said moving surface is a conveyor belt and said opening is oriented, such that said stream is extruded in a direction of movement of said conveyor belt.

14. The system of claim 1, wherein said system comprises a plurality of centrifugal pumps.

15. The system of claim 14, wherein said system comprises a plurality of second conduits.

16. The system of claim 1, wherein said system comprises a plurality of extrusion horns.

17. The system of claim 16, wherein said system comprises a plurality of second conduits, each of which is fitted with at least one of said plurality of extrusion horns.

18. The system of claim 1, wherein said food product is meat.

19. The system of claim 18, wherein said meat is poultry.

20. The system of claim 1, wherein said container comprises a food product marinater.

21. The system of claim 20, wherein said marinater is a marinating tumbler.

22. A system for preparing food products comprising:
a marinating tumbler for marinating said food products;
a pair of centrifugal pumps receiving said marinated food products from a pair of funnel-shaped portions of said tumbler, wherein each of said pumps has a sine-wave shaped impeller;
a pair of conduits through at least one of which said marinated food products is transferred from at least one of said pumps to at least one of a pair of extrusion horns; wherein each extrusion horn has an outlet opening for shaping said food products stream, having an opening width and an opening height; and wherein said opening width is greater than said opening height to shape a food products stream to a predetermined extrusion width and thickness; and
a pair of moving surfaces for receiving said stream from said extrusion horns, each of said moving surfaces having a width, each of said moving surfaces receiving said stream from at least one of said extrusion horns, and wherein each of said extrusion horns has a spreader portion and a director portion, whereby said spreader portion increases a width and decreases a height of said food products stream and said director portion limits said width of said food products stream extruded onto at least one of said moving surfaces to a width less than said moving surface's width.

23. The system of claim 22, wherein said extrusion horns are mounted parallel to each other.

24. The system of claim 22, wherein said moving surfaces are mounted parallel to each other.

25. The system of claim 22, wherein said moving surface is an oven belt.
